(19) United States
(12) Patent Application Publication
(10) Pub. No.: US 2019/0163798 A1
(43) Pub. Date: May 30, 2019

(54) PARSER FOR DYNAMICALLY UPDATING DATA FOR STORAGE

(71) Applicant: Microsoft Technology Licensing, LLC, Redmond, WA (US)

(72) Inventors: Andrew Walter Chimka, San Francisco, CA (US); Monica Marie Lewis, Menlo Park, CA (US); Mohsen Jamali, Sunnyvale, CA (US); Sandeep Wali, Sunnyvale, CA (US); Limin Liu, Cupertino, CA (US)

(21) Appl. No.: 15/827,625

(22) Filed: Nov. 30, 2017

(51) Int. Cl. G06F 17/30; G06F 17/27

(52) U.S. Cl. CPC G06F 17/30554; G06F 17/30899; G06F 17/2705; G06F 17/30557; G06F 17/30867

(57) ABSTRACT

Techniques for improving accuracy of data storage and retrieval using a parser for dynamically updating data for storage are disclosed herein. In some embodiments, a method comprises: detecting an event triggered by a user input on a device; receiving a company, a title, and a description for a posting, the company identification, the title, and the description being receiving in association with the event; generating a list of skills based on the company identification, the title, and the description, the generating the list of skills comprising: identifying a first plurality of skills based on a search using the company identification and the title, identifying a second plurality of skills based on a parsing of the description, and generating the list of skills based on the first plurality of skills and the second plurality of skills; and displaying the generated list of skills to on the device.

### TECHNICAL FIELD

The present application relates generally to systems, methods, and computer program products for improving accuracy of data storage and retrieval.

### BACKGROUND

Online services, such as networking services, often suffer from a lack of relevant data and an inclusion of irrelevant data for online postings. This lack of relevant data and inclusion of irrelevant data can cause technical problems in the performance of the online service. For example, in situations where the online service is performing a search for online postings that are associated with certain terms, relevant online postings are often omitted from the search results because of a lack of relevant terms stored in association with them, and irrelevant online postings are included in the search results because of an inclusion of irrelevant terms stored in association with them. As a result, the accuracy of the search results is diminished. Additionally, since otherwise relevant search results are omitted, users often spend a longer time on their search, consuming electronic resources (e.g., network bandwidth, computational expense of server performing search). Other technical problems from such omissions can arise as well.

### BRIEF DESCRIPTION OF THE DRAWINGS

Some embodiments of the present disclosure are illustrated by way of example and not limitation in the figures of the accompanying drawings, in which like reference numbers indicate similar elements.

FIG. 1 is a block diagram illustrating a client-server system, in accordance with an example embodiment.

FIG. 2 is a block diagram showing the functional components of a social networking service within a networked system, in accordance with an example embodiment.

FIG. 3 is a block diagram illustrating components of a database management system, in accordance with an example embodiment.

FIGS. 4A-4D illustrates a graphical user interface (GUI) at different stages of generating a list of skills for submission in association with a posting, in accordance with an example embodiment.

FIG. 5 illustrates a mapping of company identifications and job titles to job skills, in accordance with an example embodiment.

FIG. 6A illustrates a first plurality of skills identified based on a search of a database using a company identification and a job title and a second plurality of skills identified based on a parsing of a job description using natural language processing, in accordance with an example embodiment.

FIG. 6B illustrates a list of skills generated based on the first plurality of skills and the second plurality of skills, in accordance with an example embodiment.

FIG. 7 is a flowchart illustrating a method of improving accuracy of data storage and retrieval using a parser for dynamically updating data for storage, in accordance with an example embodiment.

FIG. 8 is a flowchart illustrating a method of generating a list of skills, in accordance with an example embodiment.

FIG. 9 is a flowchart illustrating a method of generating a list of skills, in accordance with an example embodiment.

FIG. 10 is a flowchart illustrating a method of improving accuracy of data storage and retrieval using a parser for dynamically updating data for storage, in accordance with an example embodiment.

FIG. 11 is a block diagram illustrating a mobile device, in accordance with some example embodiments.

FIG. 12 is a block diagram of an example computer system on which methodologies described herein may be executed, in accordance with an example embodiment.

### DETAILED DESCRIPTION

Example methods and systems of improving accuracy of data storage and retrieval using a parser for dynamically updating data for storage are disclosed. In the following description, for purposes of explanation, numerous specific details are set forth in order to provide a thorough understanding of example embodiments. It will be evident, however, to one skilled in the art that the present embodiments may be practiced without these specific details.

Some or all of the above problems may be addressed by one or more example embodiments disclosed herein. Some technical effects of the system and method of the present disclosure are to enable a computer system to improve the accuracy of data storage and retrieval. As a result, the computer system is able to conserve electronic resources (e.g., network bandwidth, computational expense of server performing search). Additionally, other technical effects will be apparent from this disclosure as well.

In some example embodiments, operations are performed by a computer system (or other machine) having a memory and at least one hardware processor, with the operations comprising: detecting a first computing event triggered by a first user input on a computing device; receiving a company identification, a job title, and a job description for a posting to be generated for publishing via an online service (e.g., on a social networking service), the company identification, the job title, and the job description being receiving in association with the first computing event; in response to the detecting of the first computing event, generating a list of skills based on the company identification, the job title, and the job description, the generating the list of skills comprising: identifying a first plurality of skills based on a search of a database using the company identification and the job title, the database storing each one of a plurality of reference skills in association with a corresponding company identification and a corresponding job title, the plurality of reference skills including the first plurality of skills; identifying a second plurality of skills based on a parsing of the job description using natural language processing; and generating the list of skills based on the first plurality of skills and the second plurality of skills; and in response to the generating of the list of skills, causing the generated list of skills to be displayed on the computing device in association with the job title and the job description.

In some example embodiments, the operations further comprise: subsequent to the causing the generated list of skills to be displayed on the computing device, receiving an instruction from the computing device to store the generated list of skills in association with the posting; in response to the instruction, storing the generated list of skills in association with the posting in a database of the online service; and performing a function of the online service using the generated list of skills stored in the database of the online service.

In some example embodiments, the performing of the function of the online service comprises: receiving a search query from another computing device, the search query including at least one of the skills in the generated list of skills stored in the database of the online service; identifying the posting based on a search of the database of the online service using the at least one of the skills; and causing the posting to be displayed on the other computing device based on the identifying of the posting.

In some example embodiments, the generating of the list of skills based on the first plurality of skills and the second plurality of skills comprises: determining that a set of skills are included in both the first plurality of skills and the second plurality of skills; and forming the generated list of skills to include the set of skills based on the determining that the set of skills are included in both the first plurality of skills and the second plurality of skills.

In some example embodiments, each one of the plurality of reference skills stored in association with the corresponding company identification and the corresponding job title is also stored in association with a corresponding score representing a measure of relevance of the one of the plurality of reference skills to the corresponding company identification and the corresponding job title, and the inclusion of the set of skills in the generated list of skills being further based on the scores of the set of skills.

In some example embodiments, at least one of the plurality of reference skills that is not in the set of skills is included in the generated list of skills based on the corresponding score of the least one of the plurality of reference skills.

In some example embodiments, the operations further comprise: subsequent to the causing the generated list of skills to be displayed on the computing device, detecting a second computing event triggered by a second user input on the computing device; receiving a modification of the job description in association with the second computing event, the modification of the job description forming a modified job description and comprising at least one of adding a term to the job description and removing a term from the job description; in response to the detecting of the second computing event, modifying the list of skills to form a modified list of skills based on the modified job description, the modifying of the list of skills comprising: identifying a third plurality of skills based on a parsing of the modified job description using natural language processing, the third plurality of skills comprising at least one skill not included in the second plurality of skills; and generating the modified list of skills based on the first plurality of skills and the third plurality of skills; and in response to the modifying of the list of skills, causing the generated modified list of skills to be displayed on the computing device.

In some example embodiments, the operations further comprise: subsequent to the causing the generated list of skills to be displayed on the computing device, detecting a second computing event triggered by a second user input on the computing device; receiving a modification of the generated list of skills in association with the second computing event, the modification of generated list of skills comprising removing one of the skills from the generated list of skills; storing the removed skill in the database in association with the posting; detecting a third computing event triggered by a third user input on the computing device; receiving a modification of the job description in association with the third computing event, the modification of the job description forming a modified job description and comprising at least one of adding a term to the job description and removing a term from the job description; in response to the detecting of the third computing event, modifying the list of skills to form a modified list of skills based on the modified job description, the modifying of the list of skills comprising: identifying a third plurality of skills based on a search of the database using the company identification and the job title, identifying a fourth plurality of skills based on a parsing of the modified job description using natural language processing; determining that one of the skills from the third plurality of skills or from the fourth plurality of skills matches the removed skill stored in the database in association with the posting; and generating the modified list of skills based on the third plurality of skills and the fourth plurality of skills, omitting the one of the skills from the modified list of skills based on the determining that the one of the skills matches the removed skill; and in response to the modifying of the list of skills, causing the generated modified list of skills to be displayed on the computing device.

In some example embodiments, the operations further comprise: accessing profiles of users of the online service, the profiles being stored by the online service; identifying common skills among the accessed profiles that have both the company identification and the job title by analyzing the profiles; and storing the identifying common skills as the plurality of reference skills in association with the company identification and the job title.

The methods or embodiments disclosed herein may be implemented as a computer system having one or more modules (e.g., hardware modules or software modules). Such modules may be executed by one or more processors of the computer system. The methods or embodiments disclosed herein may be embodied as instructions stored on a machine-readable medium that, when executed by one or more processors, cause the one or more processors to perform the instructions.

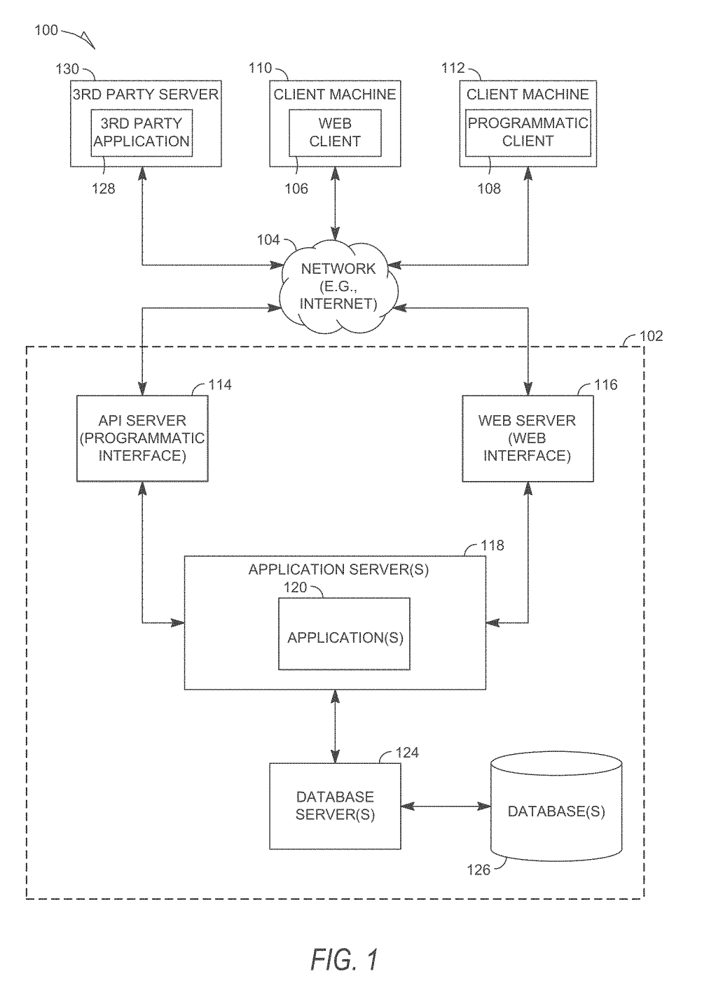

FIG. 1 is a block diagram illustrating a client-server system 100, in accordance with an example embodiment. A networked system 102 provides server-side functionality via a network 104 (e.g., the Internet or Wide Area Network (WAN)) to one or more clients. FIG. 1 illustrates, for example, a web client 106 (e.g., a browser) and a programmatic client 108 executing on respective client machines 110 and 112.

An Application Program Interface (API) server 114 and a web server 116 are coupled to, and provide programmatic and web interfaces respectively to, one or more application servers 118. The application servers 118 host one or more applications 120. The application servers 118 are, in turn, shown to be coupled to one or more database servers 124 that facilitate access to one or more databases 126. While the applications 120 are shown in FIG. 1 to form part of the networked system 102, it will be appreciated that, in alternative embodiments, the applications 120 may form part of a service that is separate and distinct from the networked system 102.

Further, while the system 100 shown in FIG. 1 employs a client-server architecture, the present disclosure is of course not limited to such an architecture, and could equally well find application in a distributed, or peer-to-peer, architecture system, for example. The various applications 120 could also be implemented as standalone software programs, which do not necessarily have networking capabilities.

The web client 106 accesses the various applications 120 via the web interface supported by the web server 116. Similarly, the programmatic client 108 accesses the various services and functions provided by the applications 120 via the programmatic interface provided by the API server 114.

FIG. 1 also illustrates a third party application 128, executing on a third party server machine 130, as having programmatic access to the networked system 102 via the programmatic interface provided by the API server 114. For example, the third party application 128 may, utilizing information retrieved from the networked system 102, support one or more features or functions on a website hosted by the third party. The third party website may, for example, provide one or more functions that are supported by the relevant applications of the networked system 102.

In some embodiments, any website referred to herein may comprise online content that may be rendered on a variety of devices, including but not limited to, a desktop personal computer, a laptop, and a mobile device (e.g., a tablet computer, smartphone, etc.). In this respect, any of these devices may be employed by a user to use the features of the present disclosure. In some embodiments, a user can use a mobile app on a mobile device (any of machines 110, 112, and 130 may be a mobile device) to access and browse online content, such as any of the online content disclosed herein. A mobile server (e.g., API server 114) may communicate with the mobile app and the application server(s) 118 in order to make the features of the present disclosure available on the mobile device.

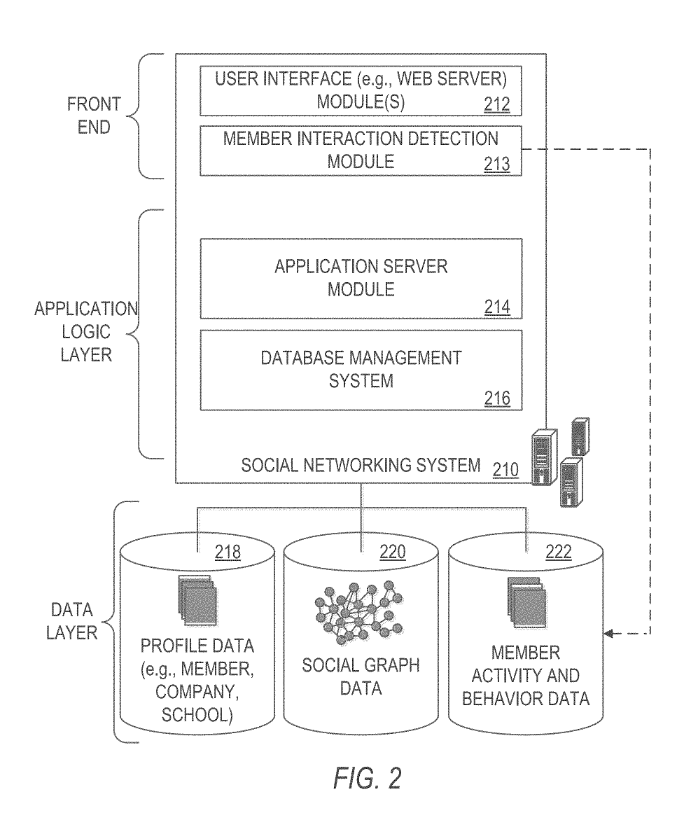

In some embodiments, the networked system 102 may comprise functional components of a social networking service. FIG. 2 is a block diagram showing the functional components of a social networking system 210, including a data processing module referred to herein as a database management system 216, for use in social networking system 210, consistent with some embodiments of the present disclosure. In some embodiments, the database management system 216 resides on application server(s) 118 in FIG. 1. However, it is contemplated that other configurations are also within the scope of the present disclosure.

As shown in FIG. 2, a front end may comprise a user interface module (e.g., a web server) 212, which receives requests from various client-computing devices, and communicates appropriate responses to the requesting client devices. For example, the user interface module(s) 212 may receive requests in the form of Hypertext Transfer Protocol (HTTP) requests, or other web-based, application programming interface (API) requests. In addition, a member interaction detection module 213 may be provided to detect various interactions that members have with different applications, services and content presented. As shown in FIG. 2, upon detecting a particular interaction, the member interaction detection module 213 logs the interaction, including the type of interaction and any meta-data relating to the interaction, in a member activity and behavior database 222.

An application logic layer may include one or more various application server modules 214, which, in conjunction with the user interface module(s) 212, generate various user interfaces (e.g., web pages) with data retrieved from various data sources in the data layer. With some embodiments, individual application server modules 214 are used to implement the functionality associated with various applications and/or services provided by the social networking service. In some example embodiments, the application logic layer includes the database management system 216.

As shown in FIG. 2, a data layer may include several databases, such as a database 218 for storing profile data, including both member profile data and profile data for various organizations (e.g., companies, schools, etc.). Consistent with some embodiments, when a person initially registers to become a member of the social networking service, the person will be prompted to provide some personal information, such as his or her name, age (e.g., birthdate), gender, interests, contact information, home town, address, the names of the member's spouse and/or family members, educational background (e.g., schools, majors, matriculation and/or graduation dates, etc.), employment history, skills, professional organizations, and so on. This information is stored, for example, in the database 218. Similarly, when a representative of an organization initially registers the organization with the social networking service, the representative may be prompted to provide certain information about the organization. This information may be stored, for example, in the database 218, or another database (not shown). In some example embodiments, the profile data may be processed (e.g., in the background or offline) to generate various derived profile data. For example, if a member has provided information about various job titles the member has held with the same company or different companies, and for how long, this information can be used to infer or derive a member profile attribute indicating the member's overall seniority level, or seniority level within a particular company. In some example embodiments, importing or otherwise accessing data from one or more externally hosted data sources may enhance profile data for both members and organizations. For instance, with companies in particular, financial data may be imported from one or more external data sources, and made part of a company's profile.

Once registered, a member may invite other members, or be invited by other members, to connect via the social networking service. A “connection” may require or indicate a bi-lateral agreement by the members, such that both members acknowledge the establishment of the connection. Similarly, with some embodiments, a member may elect to “follow” another member. In contrast to establishing a connection, the concept of “following” another member typically is a unilateral operation, and at least with some embodiments, does not require acknowledgement or approval by the member that is being followed. When one member follows another, the member who is following may receive status updates (e.g., in an activity or content stream) or other messages published by the member being followed, or relating to various activities undertaken by the member being followed. Similarly, when a member follows an organization, the member becomes eligible to receive messages or status updates published on behalf of the organization. For instance, messages or status updates published on behalf of an organization that a member is following will appear in the member's personalized data feed, commonly referred to as an activity stream or content stream In any case, the various associations and relationships that the members establish with other members, or with other entities and objects, are stored and maintained within a social graph, shown in FIG. 2 with database 220.

As members interact with the various applications, services, and content made available via the social networking system 210, the members' interactions and behavior (e.g., content viewed, links or buttons selected, messages responded to, etc.) may be tracked and information concerning the member's activities and behavior may be logged or stored, for example, as indicated in FIG. 2 by the database 222. This logged activity information may then be used by the database management system 216.

In some embodiments, databases 218, 220, and 222 may be incorporated into database(s) 126 in FIG. 1. However, other configurations are also within the scope of the present disclosure.

Although not shown, in some embodiments, the social networking system 210 provides an application programming interface (API) module via which applications and services can access various data and services provided or maintained by the social networking service. For example, using an API, an application may be able to request and/or receive one or more navigation recommendations. Such applications may be browser-based applications, or may be operating system-specific. In particular, some applications may reside and execute (at least partially) on one or more mobile devices (e.g., phone, or tablet computing devices) with a mobile operating system. Furthermore, while in many cases the applications or services that leverage the API may be applications and services that are developed and maintained by the entity operating the social networking service, other than data privacy concerns, nothing prevents the API from being provided to the public or to certain third-parties under special arrangements, thereby making the navigation recommendations available to third party applications and services.

Although the database management system 216 is referred to herein as being used in the context of a social networking service, it is contemplated that it may also be employed in the context of any website or online services. Additionally, although features of the present disclosure can be used or presented in the context of a web page, it is contemplated that any user interface view (e.g., a user interface on a mobile device or on desktop software) is within the scope of the present disclosure.

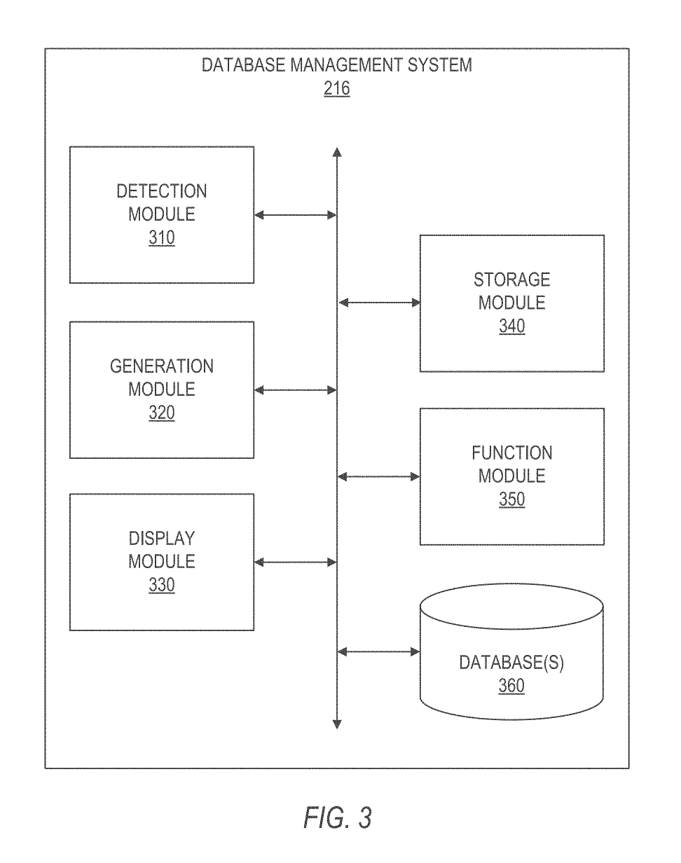

FIG. 3 is a block diagram illustrating components of the database management system 216, in accordance with an example embodiment In some embodiments, the database management system 216 comprises any combination of one or more of a detection module 310, a generation module 320, a display module 330, a storage module 340, a function module 350, and one or more database(s) 360. The modules 310, 320, 330, 340, and 350 and the database(s) 360 can reside on a computer system, or other machine, having a memory and at least one processor (not shown). In some embodiments, the modules 310, 320, 330, 340, and 350 and the database(s) 360 can be incorporated into the application server(s) 118 in FIG. 1. In some example embodiments, the database(s) 360 is incorporated into database(s) 126 in FIG. 1 and can include any combination of one or more of databases 218, 220, and 222 in FIG. 2. However, it is contemplated that other configurations of the modules 310, 320, 330, 340, and 350, as well as the database(s) 360, are also within the scope of the present disclosure.

In some example embodiments, one or more of the modules 310, 320, 330, 340, and 350 is configured to provide a variety of user interface functionality, such as generating user interfaces, interactively presenting user interfaces to the user, receiving information from the user (e.g., interactions with user interfaces), and so on. Presenting information to the user can include causing presentation of information to the user (e.g., communicating information to a device with instructions to present the information to the user). Information may be presented using a variety of means including visually displaying information and using other device outputs (e.g., audio, tactile, and so forth). Similarly, information may be received via a variety of means including alphanumeric input or other device input (e.g., one or more touch screen, camera, tactile sensors, light sensors, infrared sensors, biometric sensors, microphone, gyroscope, accelerometer, other sensors, and so forth). In some example embodiments, one or more of the modules 310, 320, 330, 340, and 350 is configured to receive user input. For example, one or more of the modules 310, 320, 330, 340, and 350 can present one or more GUI elements (e.g., drop-down menu, selectable buttons, text field) with which a user can submit input.

In some example embodiments, one or more of the modules 310, 320, 330, 340, and 350 is configured to perform various communication functions to facilitate the functionality described herein, such as by communicating with the social networking system 210 via the network 104 using a wired or wireless connection. Any combination of one or more of the modules 310, 320, 330, 340, and 350 may also provide various web services or functions, such as retrieving information from the third party servers 130 and the social networking system 210. Information retrieved by the any of the modules 310, 320, 330, 340, and 350 may include profile data corresponding to users and members of the social networking service of the social networking system 210.

Additionally, any combination of one or more of the modules 310, 320, 330, 340, and 350 can provide various data functionality, such as exchanging information with database(s) 360 or servers. For example, any of the modules 310, 320, 330, 340, and 350 can access member profiles that include profile data from the database(s) 360, as well as extract attributes and/or characteristics from the profile data of member profiles. Furthermore, the one or more of the modules 310, 320, 330, 340, and 350 can access social graph data and member activity and behavior data from database(s) 360, as well as exchange information with third party servers 130, client machines 110, 112, and other sources of information.

In some example embodiments, the database management system 216 is configured to improve accuracy of data storage and data retrieval using a parser for dynamically updating data for storage. Although this technology is useful in a variety of different use cases, one use case in which this technology is particularly useful is recommending skills to be associated with a job posting when a user (e.g., a job poster) is creating or modifying the job posting. When a user is creating a job posting, the user is not always sure what the most relevant skills for the job posting are. As a result, the user might not select or enter the most relevant skills and/or might select or enter irrelevant skills.

In some example embodiments, the database management system 216 determines a first plurality of skills based on a search of a database of skills using a company identification and a job title provided by the user, determines a second plurality of skills based on a parsing of a job description provided by the user, and generates a list of skills based on the first plurality of skills and the second plurality of skills, such as by merging the first plurality of skills with the second plurality of skills. The database management system 216 may combine the words in the job description that are skills with the most common skills for a combination of one or more attributes entered by a user, such as a particular job title, a particular company and a particular location. In some example embodiments, these most common skills are determined based on an analysis of profiles of users of a social networking service that identifies the most common skills among the profiles for the particular combination of attributes (e.g., the most common skills found in profiles that indicate that the corresponding users had a particular job title at a particular company). The database management system 216 may take the highest rated skills (e.g., based on measurements of relevance to the particular combination of attributes) that are common between the first plurality of skills and the second plurality of skills (e.g., the most overlapping relevant skills among the first plurality of skills and the second plurality of skills) and display those skills as recommendations for storage in association with the job posting.

By storing the most relevant skills for the job posting in association with the job posting, the database management system 216 enhances the functionality of the online service on which the job posting is published, such as by ensuring that the most relevant job postings are presented to users that are targeted by the online service (e.g., when notifications are presented to users, without prompting by the users, via e-mail or when the users navigate to the online service) and to users that perform a search for job postings.

In some example embodiments, the detection module 310 is configured to detect a computing event triggered by a user input on a computing device. A computing event is an action or occurrence detected or recognized by a software program. A computing event may be triggered by user input or actions, such as the user clicking a mouse button, tapping a display screen, or pressing a key. In some example embodiments, the computing event comprises a user input directed towards a position on a graphical user interface (GUI) that is identified as being outside of an area of the GUI designated for user input and in which the user has provided user input, such as by adding text to the designated area or removing text from the designated area.

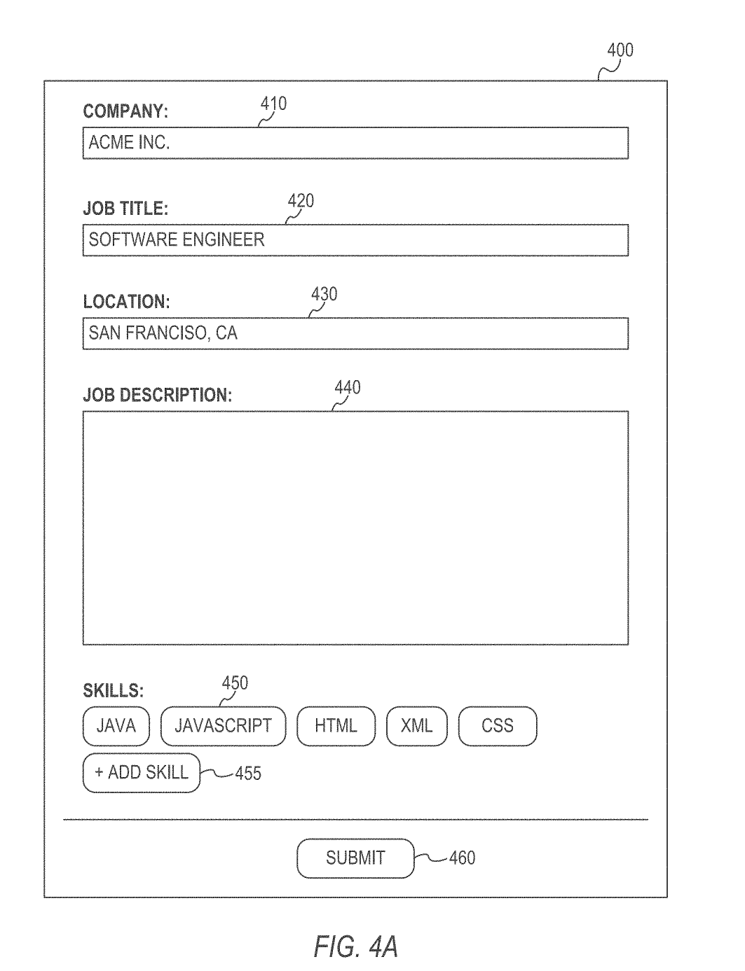

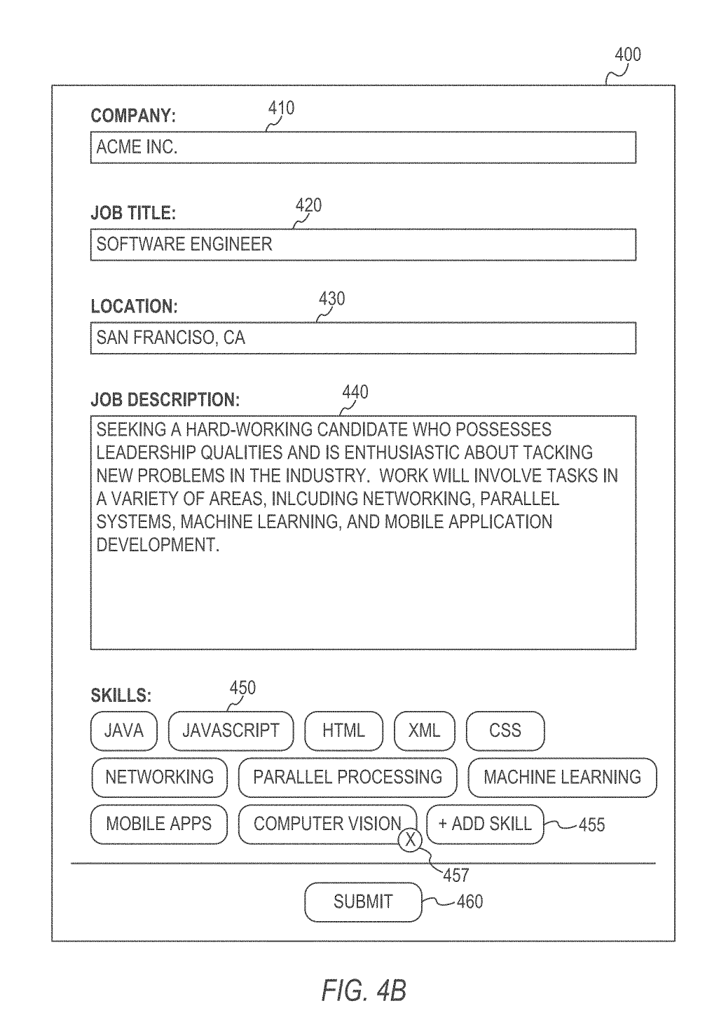

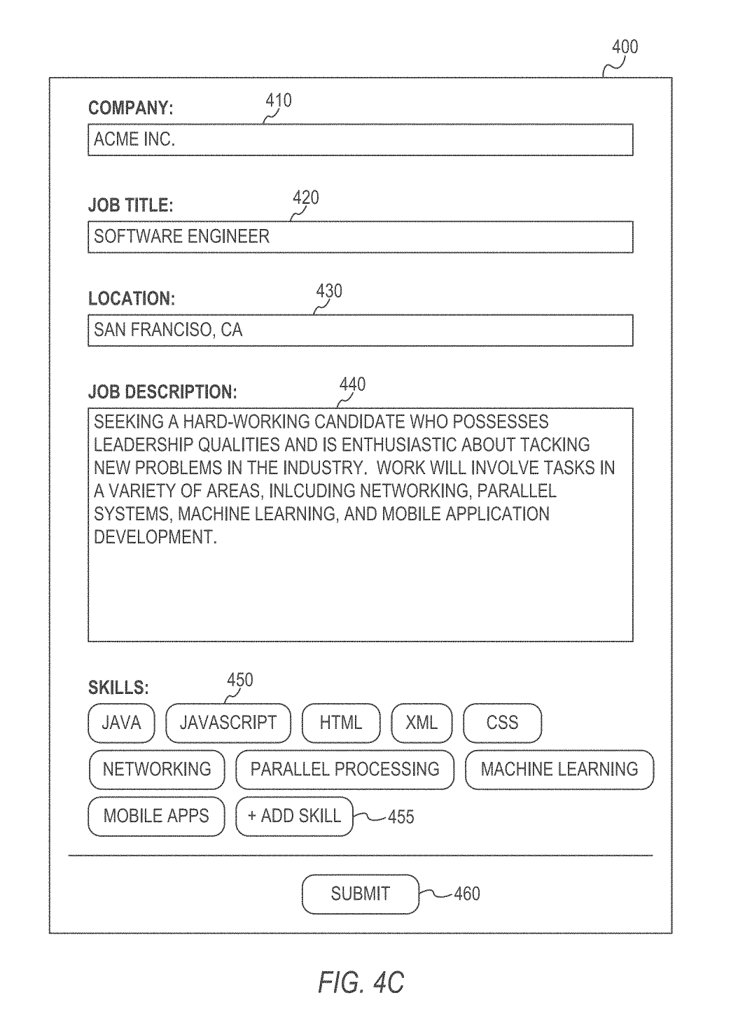

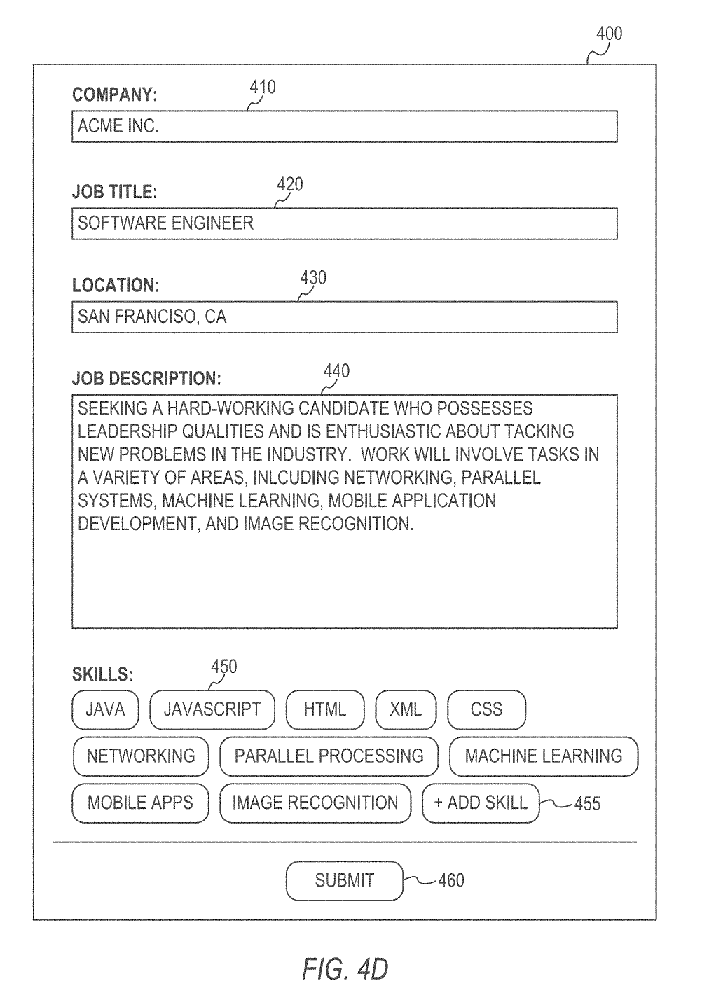

FIGS. 4A-4D illustrates a GUI 400 at different stages of generating a list of skills for submission in association with a posting, in accordance with an example embodiment In FIG. 4A, the GUI 400 comprises a page to be used by a user of the online service to create the posting. The GUI 400 in FIG. 4A comprises user interface elements configured to enable the user to enter information to be used in creating the posting, such as a text field 410 configured to receive a company identification entered by the user (e.g., “ACME INC.” in FIG. 4A”), a text field 420 configured to receive a job title entered by the user (e.g., “SOFTWARE ENGINEER” in FIG. 4A), a text field 430 configured to receive a geographical location entered by the user (e.g., “SAN FRANCISCO, CA” in FIG. 4A), and text field 440 configured to receive a job description entered by the user. Although text fields are shown in the example of FIGS. 4A-4D, other user interface elements may additionally or alternatively be used.

Referring back to FIG. 3, in some example embodiments, the generation module 320 is configured to receive one or more of a company identification, a job title, a geographical location, and a job description for a posting to be generated for publishing on a social networking service. The company identification, the job title, the geographical location, and the job description may be received in association with a computing event. For example, in FIG. 4A, after entering the company identification “ACME INC.” in the text field 410 and then the job title “SOFTWARE ENGINEER” in text field 420, the user may click or tap a position on the GUI 400 that is outside either the text field 410 or the text field 420. In response to a detection by the detection module 310 of this computing event directed to this position on the GUI 400, the generation module 320 may receive the company identification and the job title, and then generate a list of skills 450 (e.g., “JAVA,” “JAVASCRIPT.” “HTML,” “XML.” and “CSS” in FIG. 4A) based on these user-entered attributes.

In some example embodiments, the generation module 320 is configured to generate the list of skills 450 based on a user entered company identification, a user-entered job title, and a user-entered job description. The generating of the list of job skills 450 may comprise identifying a first plurality of job skills based on a search of a database (e.g., the database(s) 360 in FIG. 3) using the user-entered company identification and the user entered job title, identifying a second plurality of job skills based on a parsing of the user-entered job description using natural language processing, and generating the list of job skills 450 based on the first plurality of job skills and the second plurality of job skills In FIG. 4A, since there is not yet any user-entered job description, the list of job skills 450 is generated based only on the first plurality of job skills that is generated based on a search of a database using the user-entered company identification and the user entered job title.

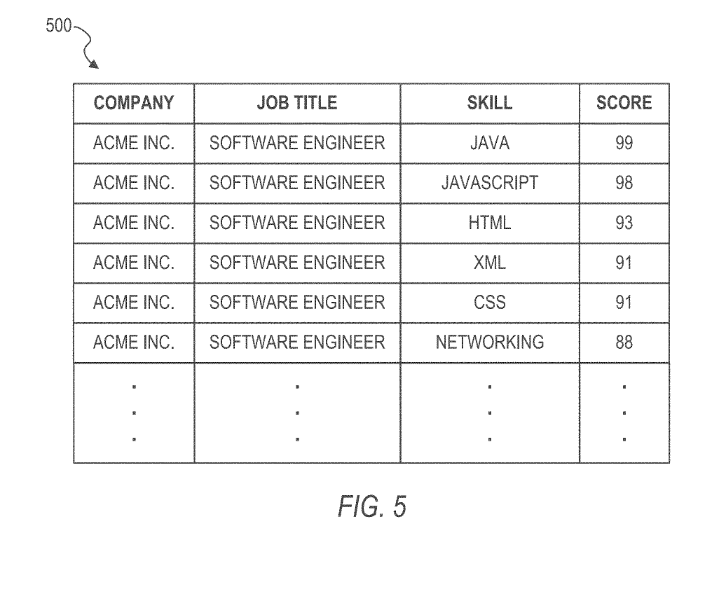

In some example embodiments, the database, such as the database(s) 360 in FIG. 3, stores each one of a plurality of reference skills in association with a corresponding company identification and a corresponding job title. The plurality of reference skills includes the first plurality of job skills, and may comprise other job skills as well. The database may comprise a mapping of attributes, such as company identifications and job titles, to job skills. FIG. 5 illustrates a mapping 500 of company identifications and job titles to job skills, in accordance with an example embodiment. As seen in FIG. 5, the combination of the company identification “ACME INC.” and the job title “SOFTWARE ENGINEER” is mapped to multiple job skills, such as “JAVA,” “JAVASCRIPT,” “HTML,” “XML,” “CSS,” and “NETWORKING” The mapping 500 may comprise other combinations of company identifications and job titles as well, and those other combinations may be mapped to the same and/or other job skills as those shown in FIG. 5.

In some example embodiments, the generation module 320 uses the mapping 500 stored in the database to identify one or more job skills based on a search of the database using the user-entered attribute(s), such as the combination of the user-entered company identification and the user-entered job title. A search for job skills based on the user-entered attribute(s) may result in a huge number of job skills being identified, which causes a technical problem in situations where the list of job skills is to be displayed on a computing device for which screen space is limited, such as on a smartphone or other mobile devices. In some example embodiments, the generation module 320 solves this technical problem by restricting the number of job skills to be displayed to within a specified maximum number In order to ensure that the most relevant job skills are presented to the user, the generation module 320 may select, from among the job skills identified based on the search of the database using the user-entered attribute(s), the job skills with the highest scores, in which the scores indicate the level of relevance of the job skills to the user-entered attribute(s). These scores may be stored in association with their corresponding attribute(s) and job skills.

In the example shown in FIG. 5, the mapping 500 indicates that the job skill “JAVA” is the most relevant job skill for the combination of the company identification “ACME INC.” and the job title “SOFTWARE ENGINEER” with a score of “99,” the job skill “JAVASCRIPT” is the second most relevant job skill for the combination of the company identification “ACME INC.” and the job title “SOFTWARE ENGINEER” with a score of “98,” the job skill “HTML” is the third most relevant job skill for the combination of the company identification “ACME INC.” and the job title “SOFTWARE ENGINEER” with a score of “93,” and so on and so forth. In one example where the generation module 320 limits the list of job skill 450 to five or less, the generation module 320 may select the five job skills with the highest relevance scores from the mapping 500 for display. In such an example, since the job skills “JAVA,” “JAVASCRIPT,” “HTML,” “XML,” and “CSS” are the five highest scoring job skills in the mapping 500, the generation module 320 selects only those five job skills for display, as seen in the example shown in FIG. 4A.

In some example embodiments, the display module 330 is configured to cause the generated list of job skills 450 to be displayed on the computing device in response to, or otherwise based on, the generating of the list of job skills 450. As seen in FIG. 4A, a selectable user interface element 455 may be displayed on the computing device in association with the list of job skills 450. The selectable user interface element 455 may be configured to enable the user to manually enter a job skill to be included in the list of job skills. For example, in response to the user selecting the selectable user interface element 455, the user may be presented with the option to type a job skill into a text field or to select a job skill from a list of job skill options (e.g., via a drop-down menu, scroll-bar menu, etc.).

In FIG. 4B, the user has entered a job description into text field 440. In some example embodiments, the generation module 320 identifies a second plurality of skills based on a parsing of the user-entered job description in response to, or otherwise based on, a detection by the detection module 310, of a computing event (e.g., a click or a tap) directed to a position on the GUI 400 that is outside the text field 440 after the user has entered the job description into the text field 440. The generation module 320 may generate the second plurality of skills using natural language processing of the user-entered job description. The natural language processing may comprise syntactic and semantic analysis operations to determine the meaning of terms in the job description. In some example embodiments, these operations comprise using a lexicon of the language in which the job description is entered, a parser, and grammar rules to break sentences of the job description into an internal representation, as well as a semantic rules or models for comprehending and interpreting the terms of the sentences. Using a natural language processing model, the generation module 320 may identify job skills based on a parsing of the job description.

In some example embodiments, the generation module 320 generates the list of job skills based on the first plurality of job skills and the second plurality of job skills by identifying the job skills that are included in both the first plurality of job skills and the second plurality of job skills. For example, the generation module 320 may determine that a set of job skills are included in both the first plurality of job skills and the second plurality of job skills, and then form the generated list of job skills to include the set of job skills based on the determination that the set of job skills are included in both the first plurality of job skills and the second plurality of job skills. Using the job skills that are common among the separately-derived pluralities of job skills, the first plurality of job skills derived based on a search using the user-entered attributes and the second plurality of job skills derived based on a parsing of the user-entered job description, the generation module 320 ensures that the most relevant job skills are included in the list of job skills presented to the user.

In the example embodiments shown in FIG. 4B, in response to the user entering the job description in text field 440 and then triggering a computing event by performing a user action directed outside of the text field 440, the generation module 440 modifies the generated list of job skills 450, adding the job skills “NETWORKING,” “PARALLEL PROCESSING,” “MACHINE LEARNING,” “MOBILE APPS,” and “COMPUTER VISION.” As discussed above, the generation module 320 may generate this modified list of job skills 450 using the job skills that are common among the separately-derived pluralities of job skills, the first plurality of job skills derived based on a search using the user-entered attributes and the second plurality of job skills derived based on a parsing of the user-entered job description.

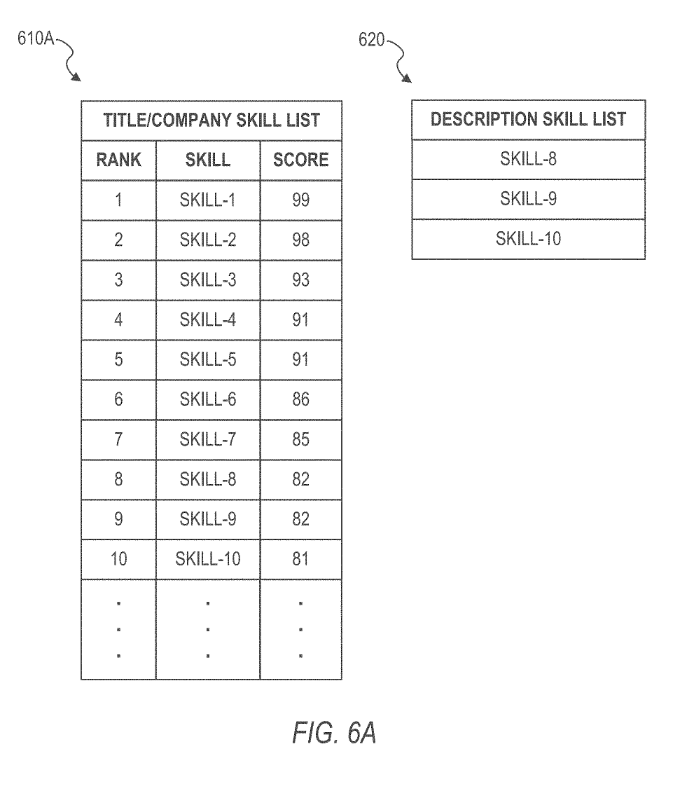

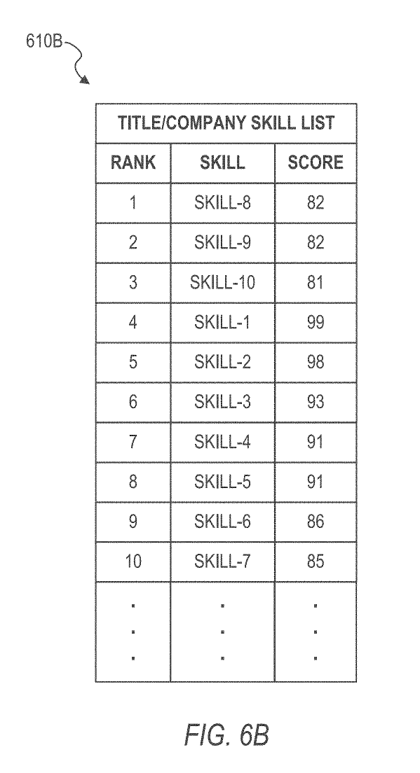

FIG. 6A illustrates a first plurality 610A of skills (e.g., “SKILL-1,” “SKILL-2,” etc.) identified based on a search of a database using a company identification and a job title and a second plurality 620 of skills (e.g., “SKILL-8,” “SKILL-9,” and “SKILL-10”) identified based on a parsing of a job description using natural language processing, in accordance with an example embodiment. In the example embodiment of FIG. 6A, the first plurality of job skills 610 are ranked based on their corresponding relevance scores.

FIG. 6B illustrates a list 610B of skills generated based on the first plurality of skills and the second plurality of skills, in accordance with an example embodiment. As seen in the example embodiment of FIG. 6B, the job skills that are common among both the first plurality 610A of job skills and the second plurality 620 of job skills are included and ranked the highest in the list 610B of skills. As a result, in the example embodiment of FIG. 61, the common skills “SKILL-8,” “SKILL-9,” and “SKILL-10” move from ranking positions 8, 9, and 10, respectively, to ranking positions 1, 2, and 3, respectively, and the remaining job skills in the list 610B of skills are each shifted down three ranking positions.

In some example embodiments, although certain job skills in the list 610B of skills are not common among both the first plurality 610A of skills and the second plurality 620 of skills, some of those job skills may still be selected by the generation module 320 for display in the list of job skills 450 on the GUI 400 based on their corresponding scores. For example, the generation module 320 may select the top five highest ranking job skills in the list 610B of skills to be displayed, in which case, job skills “SKILL-1” and “SKILL-2” would still be included in the list of job skills 450 displayed on the GUI 400 because they have ranking positions 4 and 5, respectively, in the example embodiment of FIG. 6B. In some example embodiments, the generation module 320 may omit certain job skills from the list of skills 450 to be displayed based on the corresponding relevance scores of the job skills not satisfying a threshold level of relevance (e.g., not satisfying a minimum threshold relevance score).

In some example embodiments, the storage module 340 is configured to, subsequent to the generated list of job skills 450 being displayed on the computing device, receive an instruction from the computing device to store the generated list of job skills 450 in association with the job posting, and, in response to the instruction, store the generated list of job skills 450 in association with the job posting in a database of the social networking service, such as in the database(s) 360. In some example embodiments, the user may trigger the transmission of the instruction by selecting a selectable user interface element, such as the selectable “SUBMIT” button 460 in FIGS. 4A-4D.

In some example embodiments, the function module 350 is configured to perform a function of the social networking service using the generated list of job skills 450 stored in the database of the social networking service In some example embodiments, the performing of the function of the social networking service comprises receiving, a search query from another computing device, such as the computing device of a user that is searching for job postings (as opposed to the job poster). The search query may include at least one of the job skills in the generated list of job skills 450 stored in the database of the social networking service. In some example embodiments, the function module 350 is configured to identify one or more job postings stored in association with the job skill(s) of the search query based on a search of the database of the social networking service using the job skill(s) of the search query, and then cause the identified job posting(s) to be displayed on the other computing device as search results in response to the search query.

In some example embodiments, the user may remove any particular job skills 450 from the list of job skills 450, such as by selecting a selectable user interface element 457 associated with the particular job skill 450, such as shown in FIG. 4B. In the example embodiment of FIG. 4C, the job skill “COMPUTER VISION” included in the list of job skills 450 in FIG. 4B has been removed from the list of job skills 450 in response to the selection of the selectable user interface element 457.

In some example embodiments, the storage module 340 is configured to store the removed job skill in the database(s) 360 in association with the job posting. By storing any removed job skills in association with the job posting, the database management system 216 can ensure that the user is not subsequently presented with a job skill that the user has already determined to be irrelevant. In some example embodiments, job skills that have been removed by the user are omitted from subsequent inclusion in the list of job skills 450 until the user actively adds the job skill to the list of job skills 450, such as by using the selectable user interface element 455 to manually add the job skill to the list of job skills 450. By actively adding the job skill to the list of job skills 450, the user may remove the job skill from being stored as a removed job skill in association with the job posting.

In the example embodiment of FIG. 4D, the user has modified the job description within the text field 440, adding “IMAGE RECOGNITION” to the job description. As a result of this modification to the job description, as well as a subsequent detection of a computing event triggered by a user input directed to a position on the GUI 400 outside of the text field 440, the generation module 320 modifies the list of job skills 450 to include the job skill “IMAGE RECOGNITION.” This additional job skill may be identified and added to the list of job skills 450 by the generation module 320 based on a parsing of the modified job description and an analysis of the term “IMAGE RECOGNITION.” As an example of how the storage of a removed job skill in association with the job posting can result in the omission of the removed job skill from the list of job skills 450, although the generation module 320 might identify the job skill “COMPUTER VISION” as being relevant to the term “IMAGE RECOGNITION,” the generation module 320 may omit the job skill “COMPUTER VISION” from the list of job skills 450 based on the storage of the job skill “COMPUTER VISION” in association with the job posting, even though the generation module 320 would have otherwise included the job skill “COMPUTER VISION” in the list of job skills 450 based on the modification of the job description.

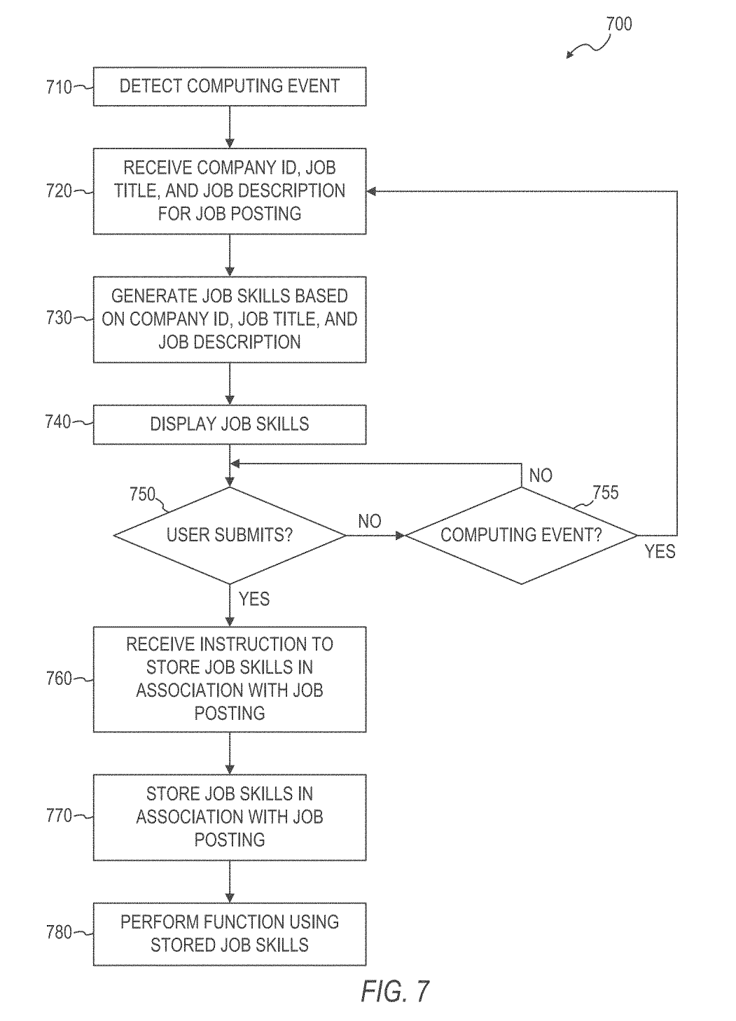

FIG. 7 is a flowchart illustrating a method 700 of improving accuracy of data storage and retrieval using a parser for dynamically updating data for storage, in accordance with an example embodiment. The method 700 can be performed by processing logic that can comprise hardware (e.g., circuitry, dedicated logic, programmable logic, microcode, etc.), software (e.g., instructions run on a processing device), or a combination thereof. In one implementation, the method 700 is performed by the database management system 216 of FIGS. 2-3, or any combination of one or more of its modules, as described above.

At operation 710, the database management system 216 detects a computing event triggered by a user input on a computing device. At operation 720, the database management system 216 receives a company identification, a job title, and a job description for a job posting to be generated for publishing on a social networking service. In some example embodiments, the company identification, the job title, and the job description are received in association with the computing event detected at operation 710. At operation 730, the database management system 216 generates a list of job skills based on the company identification, the job title, and the job description, in response to, or otherwise based on, the detection of the computing event at operation 710. At operation 740, the database management system 216 causes the generated list of job skills to be displayed on the computing device in response to, or otherwise based on, the generation of the list of job skills at operation 730.

At operation 750, the database management system 216 determines whether or not a user input indicating that the user is requesting that the list of job skills be submitted for storage in association with the job posting has been received. If the database management system 216 determines that such a user input has not been received, then, at operation 755, the database management system 216 determines whether another computing event has been detected. If the database management system 216 determines that another computing event has not been detected, then the method 700 returns to operation 750, where the database management system 216 again determines whether or not a user input has been received indicating that the user is requesting that the list of job skills be submitted for storage in association with the job posting. If, at operation 755, the database management system 216 determines that another computing event has been detected, then the method returns to operation 720, where the database management system 216 receives a modification to one or more of the company identification, the job title, and the job posting, and then performs operations 730 and 740 using the modification.

If, at operation 750, the database management system 216 determines that a user input indicating that the user is requesting that the list of job skills be submitted for storage in association with the job posting has been received, then, at operation 760, the database management system 216 receives an instruction from the computing device to store the generated list of job skills in association with the job posting. At operation 770, the database management system 216 stores the generated list of job skills in association with the job posting in a database of the social networking service in response to, or otherwise based on, the instruction. At operation 780, the database management system 216 performs a function of the social networking service using the generated list of job skills stored in the database of the networking service. In some example embodiments, the performing of the function of the social networking service comprises receiving a search query from another computing device, where the search query includes at least one of the job skills in the generated list of job skills stored in the database of the social networking service, identifying the job posting based on a search of the database of the social networking service using the at least one of the job skills, and causing the job posting to be displayed on the other computing device based on the identifying of the job posting.

It is contemplated that any of the other features described within the present disclosure can be incorporated into the method 700.

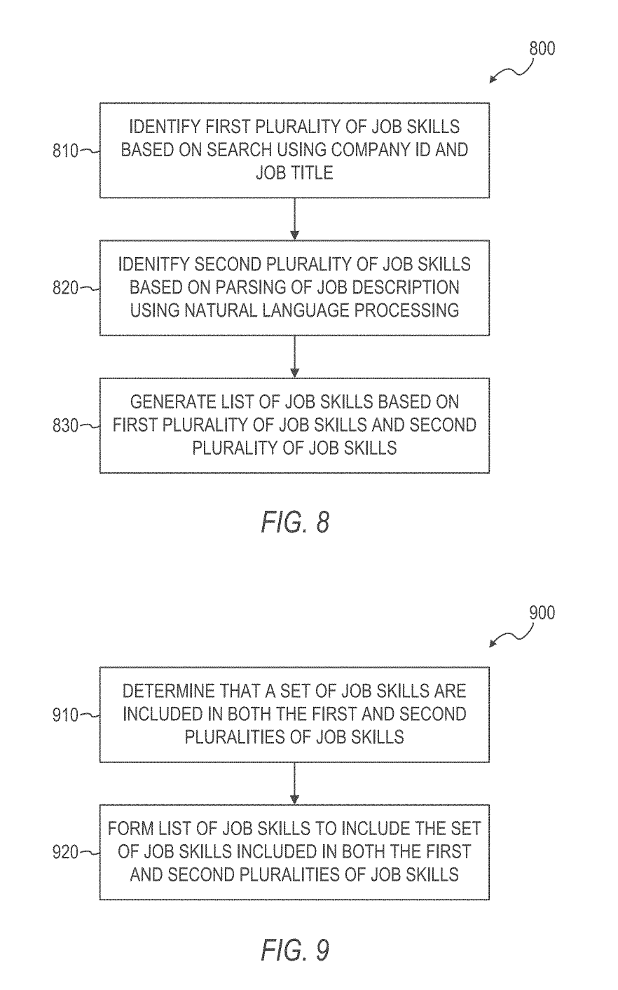

FIG. 8 is a flowchart illustrating a method 800 of generating a list of skills, in accordance with an example embodiment. The method 800 can be performed by processing logic that can comprise hardware (e.g., circuitry, dedicated logic, programmable logic, microcode, etc.), software (e.g., instructions run on a processing device), or a combination thereof. In one implementation, the method 800 is performed by the database management system 216 of FIGS. 2-3, or any combination of one or more of its modules, as described above.

At operation 810, the database management system 216 identifies a first plurality of job skills based on a search of a database using the company identification and the job title In some example embodiments, the database stores each one of a plurality of reference skills in association with a corresponding company identification and a corresponding job title, with the plurality of reference skills including the first plurality of job skills. At operation 820, the database management system 216 identifies a second plurality of job skills based on a parsing of the job description using natural language processing. At operation 830, the database management system 216 generates the list of job skills based on the first plurality of job skills and the second plurality of job skills.

In some example embodiments, each one of the plurality of reference skills stored in association with the corresponding company identification and the corresponding job title is also stored in association with a corresponding score representing a measure of relevance of the one of the plurality of reference skills to the corresponding company identification and the corresponding job title, and the inclusion of the set of job skills in the generated list of job skills is further based on the scores of the set of job skills. In some example embodiments, at least one of the plurality of reference skills that is not in the set of job skills is included in the generated list of job skills based on the corresponding score of the least one of the plurality of reference skills.

It is contemplated that any of the other features described within the present disclosure can be incorporated into the method 800.

FIG. 9 is a flowchart illustrating a method 900 of generating a list of skills, in accordance with an example embodiment. The method 900 can be performed by processing logic that can comprise hardware (e.g., circuitry, dedicated logic, programmable logic, microcode, etc.), software (e.g., instructions run on a processing device), or a combination thereof. In one implementation, the method 900 is performed by the database management system 216 of FIGS. 2-3, or any combination of one or more of its modules, as described above.

At operation 910, the database management system 216 determines that a set of job skills are included in both the first plurality of job skills and the second plurality of job skills. At operation 920, the database management system 216 forms the generated list of job skills to include the set of job skills based on the determination that the set of job skills are included in both the first plurality of job skills and the second plurality of job skills.

It is contemplated that any of the other features described within the present disclosure can be incorporated into the method 900.

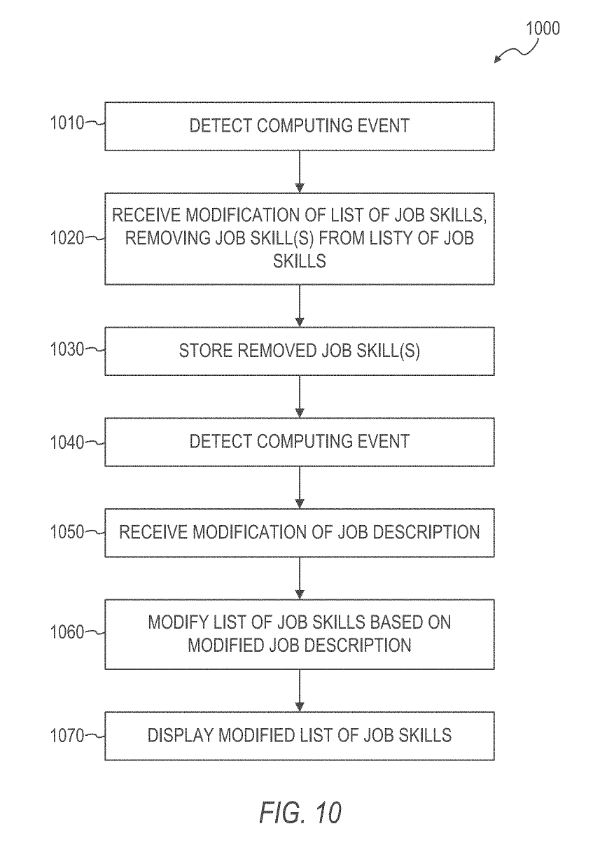

FIG. 10 is a flowchart illustrating a method 1000 of improving accuracy of data storage and retrieval using a parser for dynamically updating data for storage, in accordance with an example embodiment. The method 1000 can be performed by processing logic that can comprise hardware (e.g., circuitry, dedicated logic, programmable logic, microcode, etc.), software (e.g., instructions run on a processing device), or a combination thereof. In one implementation, the method 1000 is performed by the database management system 216 of FIGS. 2-3, or any combination of one or more of its modules, as described above.

In some example embodiments, operation 1010 is performed subsequent to operation 740 of FIG. 7. At operation 1010, the database management system 216 detects a second computing event triggered by a second user input on the computing device. At operation 1020, the database management system 216 receives a modification of the generated list of job skills in association with the second computing event. In some example embodiments, the modification of generated list of job skills comprises removing one of the job skills from the generated list of job skills. At operation 1030, the database management system 216 stores the removed job skill in the database in association with the job posting. At operation 1040, the database management system 216 detects a third computing event triggered by a third user input on the computing device. At operation 1050, the database management system 216 receives a modification of the job description in association with the third computing event. In some example embodiments, the modification of the job description forms a modified job description and comprises at least one of adding a term to the job description and removing a term from the job description.

At operation 1060, the database management system 216, in response to or otherwise based on the detection of the third computing event, modifies the list of job skills to form a modified list of job skills based on the modified job description. In some example embodiments, the modifying of the list of job skills comprises identifying a third plurality of job skills based on a search of the database using the company identification and the job title, identifying a fourth plurality of job skills based on a parsing of the modified job description using natural language processing, determining that one of the job skills from the third plurality of job skills or from the fourth plurality of job skills matches the removed job skill stored in the database in association with the job posting, and generating the modified list of job skills based on the third plurality of job skills and the fourth plurality of job skills, omitting the one of the job skills from the modified list of job skills based on the determining that the one of the job skills matches the removed job skill. At operation 1070, the database management system 216 causes the generated modified list of job skills to be displayed on the computing device in response to, or otherwise based on, the modifying of the list of job skills.

It is contemplated that any of the other features described within the present disclosure can be incorporated into the method 1000.

### Example Mobile Device

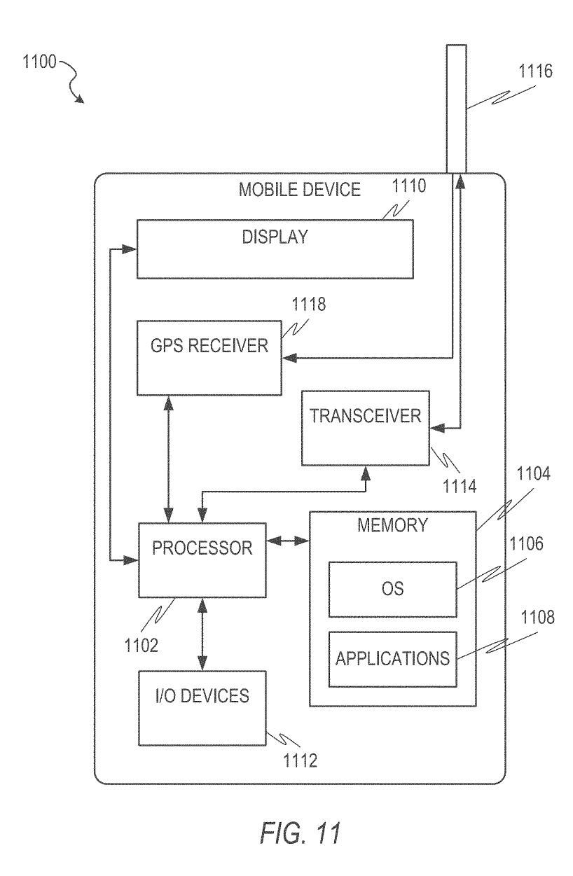

FIG. 11 is a block diagram illustrating a mobile device 1100, according to an example embodiment. The mobile device 1100 can include a processor 1102. The processor 1102 can be any of a variety of different types of commercially available processors suitable for mobile devices 1100 (for example, an XScale architecture microprocessor, a Microprocessor without Interlocked Pipeline Stages (MIPS) architecture processor, or another type of processor). A memory 1104, such as a random access memory (RAM), a Flash memory, or other type of memory, is typically accessible to the processor 1102. The memory 1104 can be adapted to store an operating system (OS) 1106, as well as application programs 1108, such as a mobile location-enabled application that can provide location-based services (LBSs) to a user. The processor 1102 can be coupled, either directly or via appropriate intermediary hardware, to a display 1110 and to one or more input/output (I/O) devices 1112, such as a keypad, a touch panel sensor, a microphone, and the like. Similarly, in some embodiments, the processor 1102 can be coupled to a transceiver 1114 that interfaces with an antenna 1116. The transceiver 1114 can be configured to both transmit and receive cellular network signals, wireless data signals, or other types of signals via the antenna 1116, depending on the nature of the mobile device 1100. Further, in some configurations, a GPS receiver 1118 can also make use of the antenna 1116 to receive GPS signals.

### Modules, Components and Logic

Certain embodiments are described herein as including logic or a number of components, modules, or mechanisms. Modules may constitute either software modules (e.g., code embodied (1) on a non-transitory machine-readable medium or (2) in a transmission signal) or hardware-implemented modules. A hardware-implemented module is tangible unit capable of performing certain operations and may be configured or arranged in a certain manner. In example embodiments, one or more computer systems (e.g., a standalone, client or server computer system) or one or more processors may be configured by software (e.g., an application or application portion) as a hardware-implemented module that operates to perform certain operations as described herein.

In various embodiments, a hardware-implemented module may be implemented mechanically or electronically. For example, a hardware-implemented module may comprise dedicated circuitry or logic that is permanently configured (e.g., as a special-purpose processor, such as a field programmable gate array (FPGA) or an application-specific integrated circuit (ASIC)) to perform certain operations. A hardware-implemented module may also comprise programmable logic or circuitry (e.g., as encompassed within a general-purpose processor or other programmable processor) that is temporarily configured by software to perform certain operations. It will be appreciated that the decision to implement a hardware-implemented module mechanically, in dedicated and permanently configured circuitry, or in temporarily configured circuitry (e.g., configured by software) may be driven by cost and time considerations.

Accordingly, the term “hardware-implemented module” should be understood to encompass a tangible entity, be that an entity that is physically constructed, permanently configured (e.g., hardwired) or temporarily or transitorily configured (e.g., programmed) to operate in a certain manner and/or to perform certain operations described herein. Considering embodiments in which hardware-implemented modules are temporarily configured (e.g., programmed), each of the hardware-implemented modules need not be configured or instantiated at any one instance in time. For example, where the hardware-implemented modules comprise a general-purpose processor configured using software, the general-purpose processor may be configured as respective different hardware-implemented modules at different times. Software may accordingly configure a processor, for example, to constitute a particular hardware-implemented module at one instance of time and to constitute a different hardware-implemented module at a different instance of time.

Hardware-implemented modules can provide information to, and receive information from, other hardware-implemented modules. Accordingly, the described hardware-implemented modules may be regarded as being communicatively coupled. Where multiple of such hardware-implemented modules exist contemporaneously, communications may be achieved through signal transmission (e.g., over appropriate circuits and buses) that connect the hardware-implemented modules. In embodiments in which multiple hardware-implemented modules are configured or instantiated at different times, communications between such hardware-implemented modules may be achieved, for example, through the storage and retrieval of information in memory structures to which the multiple hardware-implemented modules have access. For example, one hardware-implemented module may perform an operation, and store the output of that operation in a memory device to which it is communicatively coupled. A further hardware-implemented module may then, at a later time, access the memory device to retrieve and process the stored output. Hardware-implemented modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods described herein may be at least partially processor-implemented. For example, at least some of the operations of a method may be performed by one or more processors or processor-implemented modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., Application Program Interfaces (APIs).)

### Electronic Apparatus and System

Example embodiments may be implemented in digital electronic circuitry, or in computer hardware, firmware, software, or in combinations of them. Example embodiments may be implemented using a computer program product, e.g., a computer program tangibly embodied in an information carrier, e.g., in a machine-readable medium for execution by, or to control the operation of, data processing apparatus, e.g., a programmable processor, a computer, or multiple computers.

A computer program can be written in any form of programming language, including compiled or interpreted languages, and it can be deployed in any form, including as a stand-alone program or as a module, subroutine, or other unit suitable for use in a computing environment. A computer program can be deployed to be executed on one computer or on multiple computers at one site or distributed across multiple sites and interconnected by a communication network.

In example embodiments, operations may be performed by one or more programmable processors executing a computer program to perform functions by operating on input data and generating output. Method operations can also be performed by, and apparatus of example embodiments may be implemented as, special purpose logic circuitry, e.g., a field programmable gate array (FPGA) or an application-specific integrated circuit (ASIC).

The computing system can include clients and servers. A client and server are generally remote from each other and typically interact through a communication network. The relationship of client and server arises by virtue of computer programs running on the respective computers and having a client-server relationship to each other. In embodiments deploying a programmable computing system, it will be appreciated that both hardware and software architectures merit consideration. Specifically, it will be appreciated that the choice of whether to implement certain functionality in permanently configured hardware (e.g., an ASIC), in temporarily configured hardware (e.g., a combination of software and a programmable processor), or a combination of permanently and temporarily configured hardware may be a design choice. Below are set out hardware (e.g., machine) and software architectures that may be deployed, in various example embodiments.

### Example Machine Architecture and Machine-Readable Medium

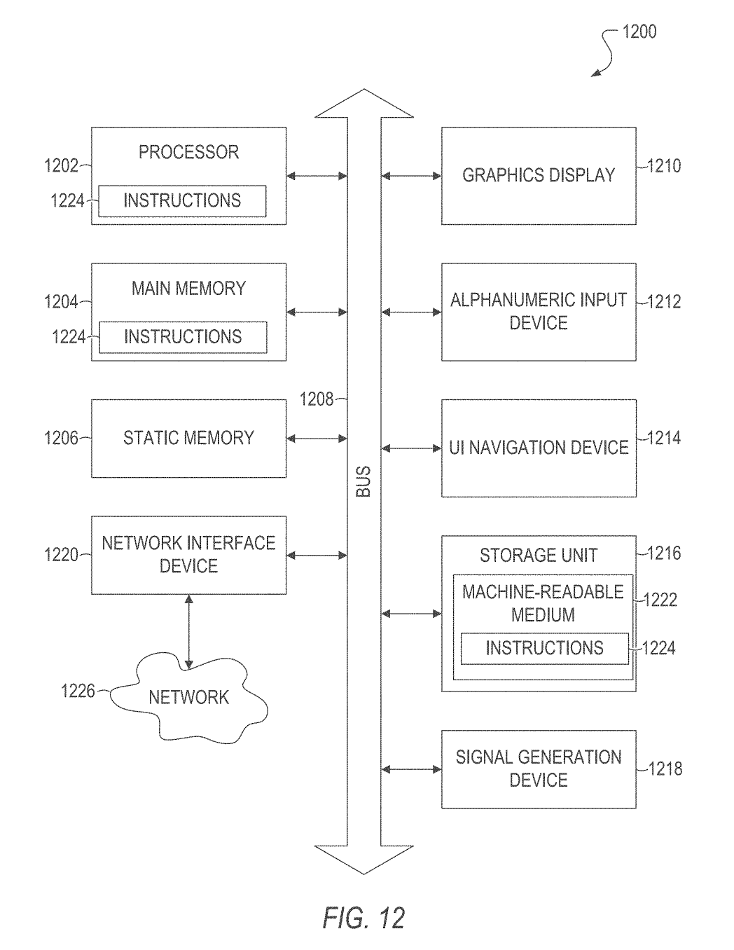

FIG. 12 is a block diagram of an example computer system 1200 on which methodologies described herein may be executed, in accordance with an example embodiment. In alternative embodiments, the machine operates as a standalone device or may be connected (e.g., networked) to other machines. In a networked deployment, the machine may operate in the capacity of a server or a client machine in server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 1200 includes a processor 1202 (e.g., a central processing unit (CPU), a graphics processing unit (GPU) or both), a main memory 1204 and a static memory 1206, which communicate with each other via a bus 1208. The computer system 1200 may further include a graphics display unit 1210 (e.g., a liquid crystal display (LCD) or a cathode ray tube (CRT)). The computer system 1200 also includes an alphanumeric input device 1212 (e.g., a keyboard or a touch-sensitive display screen), a user interface (UI) navigation device 1214 (e.g., a mouse), a storage unit 1216, a signal generation device 1218 (e.g., a speaker) and a network interface device 1220.

### Machine-Readable Medium

The storage unit 1216 includes a machine-readable medium 1222 on which is stored one or more sets of instructions and data structures (e.g., software) 1224 embodying or utilized by any one or more of the methodologies or functions described herein. The instructions 1224 may also reside, completely or at least partially, within the main memory 1204 and/or within the processor 1202 during execution thereof by the computer system 1200, the main memory 1204 and the processor 1202 also constituting machine-readable media.

While the machine-readable medium 1222 is shown in an example embodiment to be a single medium, the term “machine-readable medium” may include a single medium or multiple media (e.g., a centralized or distributed database, and/or associated caches and servers) that store the one or more instructions 1224 or data structures. The term “machine-readable medium” shall also be taken to include any tangible medium that is capable of storing, encoding or carrying instructions (e.g., instructions 1224) for execution by the machine and that cause the machine to perform any one or more of the methodologies of the present disclosure, or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including by way of example semiconductor memory devices, e.g., Erasable Programmable Read-Only Memory (EPROM), Electrically Erasable Programmable Read-Only Memory (EEPROM), and flash memory devices; magnetic disks such as internal hard disks and removable disks; magneto-optical disks; and CD-ROM and DVD-ROM disks.

### Transmission Medium

The instructions 1224 may further be transmitted or received over a communications network 1226 using a transmission medium. The instructions 1224 may be transmitted using the network interface device 1220 and any one of a number of well-known transfer protocols (e.g., HTTP). Examples of communication networks include a local area network (“LAN”), a wide area network (“WAN”), the Internet, mobile telephone networks, Plain Old Telephone Service (POTS) networks, and wireless data networks (e.g., WiFi and WiMax networks). The term “transmission medium” shall be taken to include any intangible medium that is capable of storing, encoding or carrying instructions for execution by the machine, and includes digital or analog communications signals or other intangible media to facilitate communication of such software.

Although an embodiment has been described with reference to specific example embodiments, it will be evident that various modifications and changes may be made to these embodiments without departing from the broader spirit and scope of the present disclosure. Accordingly, the specification and drawings are to be regarded in an illustrative rather than a restrictive sense. The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled. Although specific embodiments have been illustrated and described herein, it should be appreciated that any arrangement calculated to achieve the same purpose may be substituted for the specific embodiments shown. This disclosure is intended to cover any and all adaptations or variations of various embodiments. Combinations of the above embodiments, and other embodiments not specifically described herein, will be apparent to those of skill in the art upon reviewing the above description.

What is claimed is:

1. A computer-implemented method comprising:
detecting, by a computer system having a memory and at least one hardware processor, a first computing event triggered by a first user input on a computing device;
receiving, by the computer system, a company identification, a job title, and a job description for a posting to be generated for publishing via an online service, the company identification, the job title, and the job description being receiving in association with the first computing event;
in response to the detecting of the first computing event, generating, by the computer system, a list of skills based on the company identification, the job title, and the job description, the generating the list of skills comprising:
identifying a first plurality of skills based on a search of a database using the company identification and the job title, the database storing each one of a plurality of reference skills in association with a corresponding company identification and a corresponding job title, the plurality of reference skills including the first plurality of skills;
identifying a second plurality of skills based on a parsing of the job description using natural language processing; and
generating the list of skills based on the first plurality of skills and the second plurality of skills; and
in response to the generating of the list of skills, causing, by the computer system, the generated list of skills to be displayed on the computing device in association with the job title and the job description.

2. The computer-implemented method of claim 1, further comprising:
subsequent to the causing the generated list of skills to be displayed on the computing device, receiving, by the computer system, an instruction from the computing device to store the generated list of skills in association with the posting;
in response to the instruction, storing, by the computer system, the generated list of skills in association with the posting in a database of the online service; and
performing, by the computer system, a function of the online service using the generated list of skills stored in the database of the online service.

3. The computer-implemented method of claim 2, wherein the performing of the function of the online service comprises:
receiving a search query from another computing device, the search query including at least one of the skills in the generated list of skills stored in the database of the online service;
identifying the posting based on a search of the database of the online service using the at least one of the skills; and
causing the posting to be displayed on the other computing device based on the identifying of the posting.

4. The computer-implemented method of claim 1, wherein the generating of the list of skills based on the first plurality of skills and the second plurality of skills comprises:
determining that a set of skills are included in both the first plurality of skills and the second plurality of skills; and
forming the generated list of skills to include the set of skills based on the determining that the set of skills are included in both the first plurality of skills and the second plurality of skills.

5. The computer-implemented method of claim 4, wherein each one of the plurality of reference skills stored in association with the corresponding company identification and the corresponding job title is also stored in association with a corresponding score representing a measure of relevance of the one of the plurality of reference skills to the corresponding company identification and the corresponding job title, and the inclusion of the set of skills in the generated list of skills being further based on the scores of the set of skills.

6. The computer-implemented method of claim 5, wherein at least one of the plurality of reference skills that is not in the set of skills is included in the generated list of skills based on the corresponding score of the least one of the plurality of reference skills.

7. The computer-implemented method of claim 1, further comprising:
subsequent to the causing the generated list of skills to be displayed on the computing device, detecting, by the computer system, a second computing event triggered by a second user input on the computing device;
receiving, by the computer system, a modification of the job description in association with the second computing event, the modification of the job description forming a modified job description and comprising at least one of adding a term to the job description and removing a term from the job description;
in response to the detecting of the second computing event, modifying, by the computer system, the list of skills to form a modified list of skills based on the modified job description, the modifying of the list of skills comprising:
identifying a third plurality of skills based on a parsing of the modified job description using natural language processing, the third plurality of skills comprising at least one skill not included in the second plurality of skills; and
generating the modified list of skills based on the first plurality of skills and the third plurality of skills; and
in response to the modifying of the list of skills, causing, by the computer system, the generated modified list of skills to be displayed on the computing device.

8. The computer-implemented method of claim 1, further comprising:
subsequent to the causing the generated list of skills to be displayed on the computing device, detecting, by the computer system, a second computing event triggered by a second user input on the computing device;
receiving, by the computer system, a modification of the generated list of skills in association with the second computing event, the modification of generated list of skills comprising removing one of the skills from the generated list of skills;
storing, by the computer system, the removed skill in the database in association with the posting;
detecting, by the computer system, a third computing event triggered by a third user input on the computing device;
receiving, by the computer system, a modification of the job description in association with the third computing event, the modification of the job description forming a modified job description and comprising at least one of adding a term to the job description and removing a term from the job description;
in response to the detecting of the third computing event, modifying, by the computer system, the list of skills to form a modified list of skills based on the modified job description, the modifying of the list of skills comprising:
identifying a third plurality of skills based on a search of the database using the company identification and the job title;
identifying a fourth plurality of skills based on a parsing of the modified job description using natural language processing;
determining that one of the skills from the third plurality of skills or from the fourth plurality of skills matches the removed skill stored in the database in association with the posting; and
generating the modified list of skills based on the third plurality of skills and the fourth plurality of skills, omitting the one of the skills from the modified list of skills based on the determining that the one of the skills matches the removed skill; and
in response to the modifying of the list of skills, causing, by the computer system, the generated modified list of skills to be displayed on the computing device.

9. The computer-implemented method of claim 1, further comprising:
accessing, by the computer system, profiles of users of the online service, the profiles being stored by the online service;
identifying, by the computer system, common skills among the accessed profiles that have both the company identification and the job title by analyzing the profiles; and
storing, by the computer system, the identifying common skills as the plurality of reference skills in association with the company identification and the job title.

10. A system comprising:
at least one hardware processor; and
a non-transitory machine-readable medium embodying a set of instructions that, when executed by the at least one hardware processor, cause the at least one processor to perform operations, the operations comprising:
detecting a first computing event triggered by a first user input on a computing device;
receiving a company identification, a job title, and a job description for a posting to be generated for publishing via an online service, the company identification, the job title, and the job description being receiving in association with the first computing event;
in response to the detecting of the first computing event, generating a list of skills based on the company identification, the job title, and the job description, the generating the list of skills comprising:
identifying a first plurality of skills based on a search of a database using the company identification and the job title, the database storing each one of a plurality of reference skills in association with a corresponding company identification and a corresponding job title, the plurality of reference skills including the first plurality of skills;
identifying a second plurality of skills based on a parsing of the job description using natural language processing; and
generating the list of skills based on the first plurality of skills and the second plurality of skills; and
in response to the generating of the list of skills, causing the generated list of skills to be displayed on the computing device in association with the job title and the job description.

11. The system of claim 10, wherein the operations further comprise:
subsequent to the causing the generated list of skills to be displayed on the computing device, receiving an instruction from the computing device to store the generated list of skills in association with the posting;
in response to the instruction, storing the generated list of skills in association with the posting in a database of the online service; and
performing a function of the online service using the generated list of skills stored in the database of the online service.

12. The system of claim 11, wherein the performing of the function of the online service comprises:
receiving a search query from another computing device, the search query including at least one of the skills in the generated list of skills stored in the database of the online service;
identifying the posting based on a search of the database of the online service using the at least one of the skills; and
causing the posting to be displayed on the other computing device based on the identifying of the posting.

13. The system of claim 10, wherein the generating of the list of skills based on the first plurality of skills and the second plurality of skills comprises:
determining that a set of skills are included in both the first plurality of skills and the second plurality of skills; and
forming the generated list of skills to include the set of skills based on the determining that the set of skills are included in both the first plurality of skills and the second plurality of skills.

14. The system of claim 13, wherein each one of the plurality of reference skills stored in association with the corresponding company identification and the corresponding job title is also stored in association with a corresponding score representing a measure of relevance of the one of the plurality of reference skills to the corresponding company identification and the corresponding job title, and the inclusion of the set of skills in the generated list of skills being further based on the scores of the set of skills.

15. The system of claim 14, wherein at least one of the plurality of reference skills that is not in the set of skills is included in the generated list of skills based on the corresponding score of the least one of the plurality of reference skills.

16. The system of claim 10, wherein the operations further comprise:
subsequent to the causing the generated list of skills to be displayed on the computing device, detecting a second computing event triggered by a second user input on the computing device;
receiving a modification of the job description in association with the second computing event, the modification of the job description forming a modified job description and comprising at least one of adding a term to the job description and removing a term from the job description;
in response to the detecting of the second computing event, modifying the list of skills to form a modified list of skills based on the modified job description, the modifying of the list of skills comprising:
identifying a third plurality of skills based on a parsing of the modified job description using natural language processing, the third plurality of skills comprising at least one skill not included in the second plurality of skills; and
generating the modified list of skills based on the first plurality of skills and the third plurality of skills, and
in response to the modifying of the list of skills, causing the generated modified list of skills to be displayed on the computing device.

17. The system of claim 10, wherein the operations further comprise:
subsequent to the causing the generated list of skills to be displayed on the computing device, detecting a second computing event triggered by a second user input on the computing device;
receiving a modification of the generated list of skills in association with the second computing event, the modification of generated list of skills comprising removing one of the skills from the generated list of skills;
storing the removed skill in the database in association with the posting;
detecting a third computing event triggered by a third user input on the computing device;
receiving a modification of the job description in association with the third computing event, the modification of the job description forming a modified job description and comprising at least one of adding a term to the job description and removing a term from the job description;
in response to the detecting of the third computing event, modifying the list of skills to form a modified list of skills based on the modified job description, the modifying of the list of skills comprising:
identifying a third plurality of skills based on a search of the database using the company identification and the job title;
identifying a fourth plurality of skills based on a parsing of the modified job description using natural language processing;
determining that one of the skills from the third plurality of skills or from the fourth plurality of skills matches the removed skill stored in the database in association with the posting; and
generating the modified list of skills based on the third plurality of skills and the fourth plurality of skills, omitting the one of the skills from the modified list of skills based on the determining that the one of the skills matches the removed skill; and
in response to the modifying of the list of skills, causing the generated modified list of skills to be displayed on the computing device.

18. A non-transitory machine-readable medium embodying a set of instructions that, when executed by at least one hardware processor, cause the processor to perform operations, the operations comprising:
detecting a first computing event triggered by a first user input on a computing device;
receiving a company identification, a job title, and a job description for a posting to be generated for publishing via an online service, the company identification, the job title, and the job description being receiving in association with the first computing event;
in response to the detecting of the first computing event, generating a list of skills based on the company identification, the job title, and the job description, the generating the list of skills comprising:
identifying a first plurality of skills based on a search of a database using the company identification and the job title, the database storing each one of a plurality of reference skills in association with a corresponding company identification and a corresponding job title, the plurality of reference skills including the first plurality of skills;
identifying a second plurality of skills based on a parsing of the job description using natural language processing; and
generating the list of skills based on the first plurality of skills and the second plurality of skills; and
in response to the generating of the list of skills, causing the generated list of skills to be displayed on the computing device in association with the job title and the job description.

19. The non-transitory machine-readable medium of claim 18, wherein the operations further comprise:
subsequent to the causing the generated list of skills to be displayed on the computing device, receiving an instruction from the computing device to store the generated list of skills in association with the posting;
in response to the instruction, storing the generated list of skills in association with the posting in a database of the online service; and
performing a function of the online service using the generated list of skills stored in the database of the online service.

20. The non-transitory machine-readable medium of claim 19, wherein the performing of the function of the online service comprises:
receiving a search query from another computing device, the search query including at least one of the skills in the generated list of skills stored in the database of the online service;
identifying the posting based on a search of the database of the online service using the at least one of the skills; and
causing the posting to be displayed on the other computing device based on the identifying of the posting.
